(19) United States
(12) Patent Application Publication
(10) Pub. No.: US 2010/0205030 A1
(43) Pub. Date: Aug. 12, 2010

(54) SYSTEMS AND METHODS FOR FACTOR-BASED PRICING FOR PRODUCTS AND SERVICES

(75) Inventor: Brad Gilreath, Smyrna, GA (US)

Correspondence Address: SUTHERLAND ASBILL & BRENNAN LLP, 999 PEACHTREE STREET, N.E., ATLANTA, GA, 30309, US

(73) Assignee: Brad Gilreath, Smyrna, GA (US)

(21) Appl. No.: 12/702,018

(22) Filed: Feb. 8, 2010

Related U.S. Application Data
(60) Provisional application No. 61/150,355, filed on Feb. 6, 2009.

(51) Int. Cl. G06Q 10/00

(52) U.S. Cl. 705/9; 705/8; 705/348; 705/400; 705/418

(57) ABSTRACT

Embodiments of the invention are systems and methods for determining factor-based prices for products and services. In one embodiment, a method for factor-based pricing of goods and services can be provided. The method can include receiving a plurality of factors associated with a pricing decision, applying at least one rule to the plurality of factors to determine a proposed price, outputting the proposed price to at least one client device.

### RELATED APPLICATION

This application claims priority to U.S. Ser. No. 61/150,355 titled “Systems and Methods for Factor-Based Pricing for Products and Services,” filed on Feb. 6, 2009, the contents of which are incorporated by reference.

### TECHNICAL FIELD

The invention relates generally to pricing analytics, and more particularly, to systems and methods for factor-based pricing for products and services

### BACKGROUND OF THE INVENTION

In many instances, everyone or everything has a price.

Generally, price is a combination of real costs, emotional costs, perceived benefits, and expected profit. Unfortunately, conventional accounting methods for determining price do not use all of these factors.

Conventional pricing methods do not cover all of these factors. Cost-plus pricing may not be used in some instances because it deals with accounting cost plus expected profits. In contrast, value-based pricing can be based on the perceived benefits, whereas performance-based pricing relates to outcomes only.

These factors, for example, each represent unique challenges to quantify and relate. Real costs can be calculated, in some instances, by Generally Accepted Accounting Principles (GAAP), and provide the basis for most well-known, accepted pricing methods. Emotional costs can be much more difficult to capture, and there are no conventionally accepted methodologies for determining emotional costs outside of measuring real costs associated with emotions. Perceived benefits and expected profits may never materialize, or may heavily involve aspects of emotional costs.

Price can be very subjective, particularly for pricing services. For example, prices or rates for two software developers or programmers on a single development project can be vastly different, but the outcomes could be the same. The client can make a subjective assessment about which factors he or she would use to judge the rates or prices of the individual software developers or programmers. The individual software developers or programmers may find it difficult to justify their respective rates or prices to the client.

The process of negotiating a price sometimes lacks a finite framework. Telephone calls and emails can be exchanged and contracts can be vetted, however, while these may show that parties established a rate, they may not lead the parties to equitably establish that rate.

The process of negotiating a price in a traditional sense can often depend on the skills of the negotiators and the advantageous positions they extract. However, many negotiations may be unsuccessful, and in some instances, one party may gain a larger advantage over the other, leaving one party disgruntled about the outcome. In yet other cases, relatively important points of negotiation can be forgotten or otherwise minimized by the negotiations.

In certain instances, professional service organizations may not adequately assign employees based on their individual values to the organization. Sometimes, such organizations fail to achieve the goal of satisfying client demands. Such circumstances can lead to employee turnover, and thus, lost investment time and resources for the service organization.

Accordingly, there is a need for determining a price for products and services. There is also a need for a relatively consistent, transparent method to price products and services. There is also a need to establish a process framework to negotiate a price. There is also a need to apply certain outcomes to independent agents as well as relatively large service organizations.

### SUMMARY OF THE INVENTION

Embodiments of the invention can address some or all of the above needs. Embodiments of the invention can provide systems and methods for factor-based pricing of products and services.

Certain embodiments of the invention can collect some or all factors associated with a pricing decision, and render a price and an action. Certain embodiments of the invention can implement any number of rate negotiation techniques. For example, an example method can include direct interaction from a user with any number of specific factors to result in a newer price. In this manner, an assessment can be provided that consistently evaluates pricing situations using any number of specific factors. An output can be, for example, a comparison of an ideal price, for ideal situations, and the current situation. The output can also include guidance on whether to raise or lower a price or a rate. In certain embodiments, organizational or company resources can be allocated to any number of projects based on arbitrage of price.

In one embodiment, a system for factor-based pricing of goods and services can be provided. The system can include a price determination engine operable to receive a plurality of factors associated with a pricing decision, apply at least one rule to the plurality of factors to determine a proposed price, and output the proposed price to at least one client device.

In one aspect of the embodiment, the system can also include an evaluation creator module, and operable to assess at least one of the plurality of factors to determine an ideal set of factors; and based at least in part on the ideal set of factors, determine an ideal price.

In one aspect of the embodiment, the system can also include a template creator module operable to, based at least in part on a factorless price, provide at least one template to obtain the plurality of factors from at least one user, and output the at least one template to the user to enter the plurality of factors associated with a pricing decision.

In one aspect of the embodiment, the system can also include an organization manager module operable to, based at least in part on the plurality of factors, assign one or more resources to an engagement.

In another embodiment, a method for factor-based pricing of goods and services can be provided. The method can include receiving a plurality of factors associated with a pricing decision, applying at least one rule to the plurality of factors to determine a proposed price, outputting the proposed price to at least one client device.

In one aspect of the embodiment, the method can include assessing at least one of the plurality of factors to determine an ideal set of factors, and based at least in part on the ideal set of factors, determining an ideal price.

In one aspect of the embodiment, the method can include based at least in part on a factorless price, providing at least one template to obtain the plurality of factors from at least one user, and outputting the at least one template to the user to enter the plurality of factors associated with a pricing decision.

In one aspect of the embodiment, the method can also include assigning one or more resources to an engagement based at least in part on the plurality of factors.

In another embodiment, a computer-implemented method can be provided. The method can be implements by at least one processor operable to execute a set of computer-executable instructions. The set of instructions can include receiving a plurality of factors associated with a pricing decision, applying at least one rule to the plurality of factors to determine a proposed price, and outputting the proposed price to at least one client device.

### BRIEF DESCRIPTION OF DRAWINGS

Having thus described the invention in general terms, reference will now be made to the accompanying drawings, which are not necessarily drawn to scale, and wherein:

FIG. 1 illustrates an example system for determining a factor-based price for goods and services in accordance with an embodiment of the invention.

FIGS. 2-4 illustrate example methods for determining a factor-based price for goods and services in accordance with an embodiment of the invention.

FIGS. 5, 6A-6H, 7A-7C, 8A-8C illustrate example webpages facilitated by an example website in accordance with certain embodiments of the invention.

FIG. 9 illustrates an example data flow for a method in accordance with an embodiment of the invention.

FIGS. 10A-10B illustrate example webpages facilitated by an example website in accordance with certain embodiments of the invention.

FIG. 11 illustrates an example algorithm for use with systems and methods according to an embodiment of the invention.

FIGS. 12-14 illustrate example webpages facilitated by an example website in accordance with certain embodiments of the invention.

### DETAILED DESCRIPTION OF EXAMPLE EMBODIMENTS

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

As used herein the term “evaluation” and its plural form can refer to a scenario or expected event, which a user such as a business person wants to model or otherwise evaluate.

As used herein, the term “factor” and its plural form can mean any component used in an evaluation to assess a task, capability, avoidance, requirement, or other component of a topic. Factors can include, but are not limited to, a category, name and/or title, description, impact, help, mitigation, and answer set.

As used herein, the term “template” and its plural form can mean any data associated with describing one or more factors. A template can, for example, include a title, a description, and a costing basis, such as a factorless price associated one or more factors or set of factors.

As used herein, the term “evaluation” and its plural form can mean a particular instance or scenario that a user desires to analyze.

As used herein, the term “resource” and its plural form can mean personnel, equipment, a quantity of goods, or a quantity of services.

Certain embodiments of the invention can provide systems and methods for factor-based pricing of products and services. Such systems and methods can facilitate a website operable to collect factor data, assess one or more pricing situations, apply one or more rules consistently for a specific set of factors, and manage an organization's pricing efforts. In one embodiment, at least three processes or activities can be facilitated by the system 100: (1) evaluation creator role, (2) template creator role, and (3) organization manager role. Any combination of hardware and/or software can facilitate a respective or single (or multiple) program application(s) or module(s) to facilitate, moderate or otherwise handle each role. In this manner, a single user can interact with each module, or a single module, for each role, to determine a price.

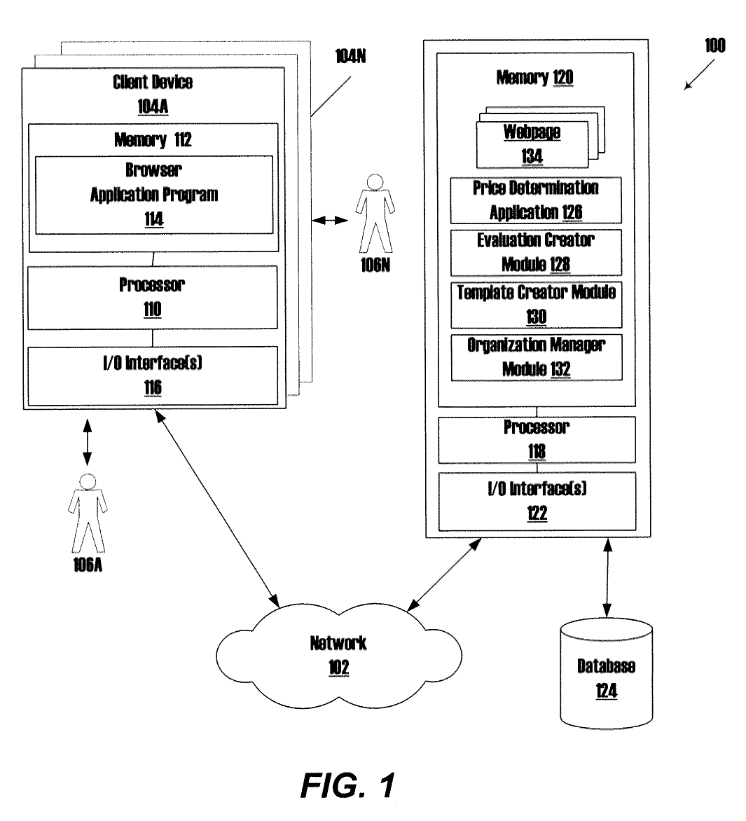

FIG. 1 illustrates an example environment and system in accordance with an embodiment of the invention. In this example, the environment can be a client-server configuration, and the system can be a factor-based pricing system 100. The system 100 is shown with a communications network 102, such as the Internet and/or a telephone network, in communication with one or more client devices 104A-104N, such as personal computers, mobile phones, or other telecommunications devices. The client devices 104A-104N are typically implemented by respective users 106A-N. The system 100 can include at least one host server 108, such as may be operated by or on behalf of a system administrator or host server administrator. It will be appreciated that while the disclosure may in certain instances describe only a host server such as 108, there may be multiple servers, without departing from example embodiments of the invention.

The communications network 102 shown in FIG. 1 may include any telecommunication and/or data network, whether public, private, or a combination thereof, including a local area network, a wide area network, an intranet, an internet, the Internet, intermediate hand-held data transfer devices, a publicly switched telephone network (“PSTN”), a cellular network, and/or any combination thereof and may be wired and/or wireless. The network 102 may also allow for real-time, off-line, and/or batch transactions to be transmitted between or among the client devices 104A-104N, and host server 108. Due to network connectivity, various methodologies as described herein may be practiced in the context of distributed computing environments. It will also be appreciated that the network 102 may include a plurality of networks, each with devices such as gateways and routers for providing connectivity between or among networks 102. Instead of, or in addition to, a network 102, dedicated communication links may be used to connect the various devices in accordance with an example embodiment invention. For example, the host server 108 may form the basis of network 102 that interconnects any number of client devices, such as 104A-104N.

In the system illustrated in FIG. 1, at least one user such as 106A may operate a client device such as 104A. The client device 104A-104N may be any processor-based device operable to communicate over a network. Example client devices include personal computers, mobile computers, handheld portable computers, digital assistants, personal digital assistants, cellular phones, mobile phones, smart phones, pagers, digital tablets, desktop computers, laptop computers, Internet appliance, or any other processor-based device. A respective communication or input/output interface associated with each client device 104A-104N can facilitate communications between the client device 104A-104N and the network 102. Each client device 104A-104N can include a processor 110 and a computer-readable medium, such as a random access memory (“RAM”), read only memory (“ROM”), and/or a removable storage device, coupled to the processor. The processor can execute computer-executable program instructions stored in memory 112. Client devices 104A-104N may operate on any operating system capable of supporting a browser or browser-enabled application including, but not limited to, Microsoft Windows®, Apple OSX™, and Linux. The client devices 104A-104N shown include, for example, personal computers executing a browser application program 114 such as Microsoft Corporation's Internet Explorer™, Netscape Communication Corporation's Netscape Navigator™, and Apple's Safari™, and Mozilla Firefox™. The client devices 104A-104N can also include one or more input/output (“I/O”) interface(s) 116 to facilitate communication with one or more other components of the system 100, for instance, with one or more host servers, such as 108.

As mentioned, the system 100 can include one or more host servers, such as 108, in communication with the client devices 104A-104N over the one or more networks 102. The host server 108 is used to facilitate processing one or more price determinations. In other embodiments, the host server 108 may be a distributed system, and at least some of the functionality described herein with reference to the host server 108 may be performed in a distributed manner by one or more of the other entities and/or components described herein.

The host server 108 can include at least one processor 118, a memory 120, and one or more I/O interface(s) 122. The memory 120 may be any computer-readable medium, such as RAM, ROM, and/or a removable storage device, coupled to the processor 118. The memory 120 may include an operating system (“OS”), such as, but not limited to, Microsoft Windows®, Apple OSX™, or Linux, and a database management system (“DBMS”) to facilitate management of data files and data stored in the memory 120 and/or stored in a data store 124, for example. The processor 118 is operable to execute computer-executable program instructions stored in memory 120, which may include a price determination application 126 or engine.

The price determination application 126 or engine can include instructions or otherwise be operable to receive a plurality of factors associated with a pricing decision, apply at least one rule to the plurality of factors to determine a proposed price, and output the proposed price to at least one client device. The price determination application 126 or engine can also include an evaluation creator module or application, such as 128, which can include instructions or otherwise be operable to assess at least one of the plurality of factors to determine an ideal set of factors, and based at least in part on the ideal set of factors, determine an ideal price. Further, the price determination application 126 or engine can also include a template creator module or application, such as 130, which can include instructions or otherwise be operable to provide based at least in part on a factorless price at least one template to obtain the plurality of factors from at least one user, and output the at least one template to the user to enter the plurality of factors associated with a pricing decision. Moreover, the price determination application 126 or engine can also include an organization manager module or application, such as 132, which can include instructions or otherwise be operable to assign one or more resources to an engagement based at least in part on the plurality of factors. In other embodiments, a price determination application or engine, such as 126, can include fewer or greater numbers of modules or applications. In yet other embodiments, some or all of the functionality associated with the application 126 and other modules such as 128, 130, 132 can be stored and/or implemented by other processors associated with one or more client devices such as 104A-104N, or other servers similar to 108.

The price determination application 126 or engine may additionally operate in conjunction with one or more of the I/O interfaces 122 to facilitate communication with one or more other components of the system 100, for instance, with one or more client devices 104A-104N. Furthermore, the price determination application 126 or engine and any of the modules 128, 130, 132 can facilitate generation and modification of one or more webpages 134 for a website hosted by the host server 108 or other server. In certain instances, a dedicated web page server or device can facilitate the generation and modification of one or more webpages such as 134 upon the direction of the price determination application 126 or engine, and any of the modules 128, 130, 132.

It will be appreciated that some or all of the functionality associated with the host server 108 may be implemented on a general purpose computer or may be a specialized machine in which a computer is customized to perform at least the functions of the price determination application 126 or engine, according to an example embodiment of the invention. One may also appreciate that some or all of the functionality provided by the host server 108 may be distributed to or otherwise reside in one or more system components, such as client devices 104A-104N, memories 112, 120, and data store 124.

Generally, each of the memories, such as the memory 120 and the data store 124 associated with the host server 108, and those associated with the client devices 104A-104N, can store data and information for subsequent retrieval. In this manner, the system 100 can store various received or collected information in memory or a database associated with one or more client devices 104A-104N and/or host server 108. The memories and data stores or databases can be in communication with each other and/or other databases, such as a centralized database, or other types of data storage devices. When needed, data or information stored in a memory or database may be transmitted to a centralized database capable of receiving data, information, or data records from more than one database or other data storage devices. In other embodiments, the data stores or databases shown can be integrated or distributed into any number of databases or data stores.

Suitable processors for client devices 104A-104N, and/or host server 108 may comprise a microprocessor, an ASIC, and state machine. Example processors can be those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor, such as the processor 118 of the host server 108, or any other processors, for example those used by the client devices 104A-104N with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

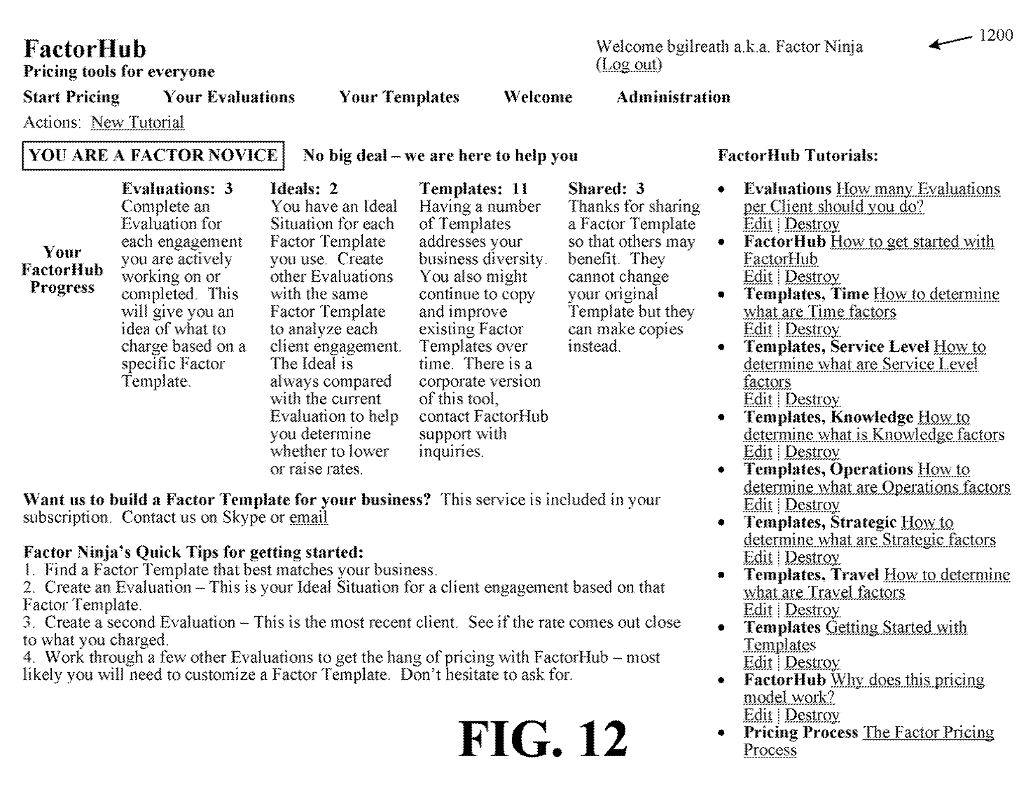

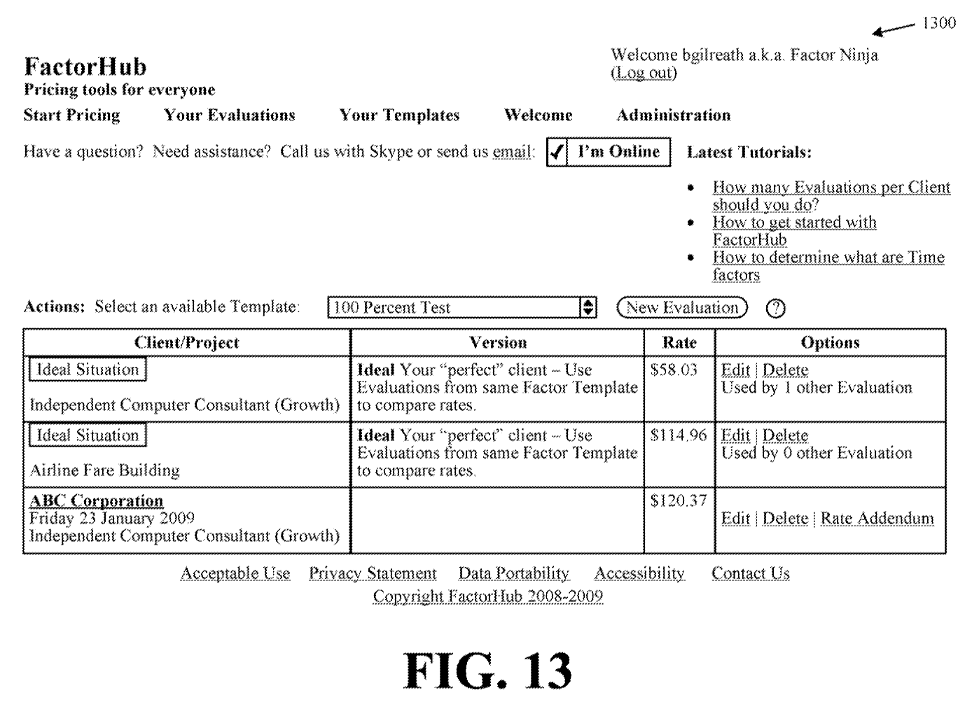

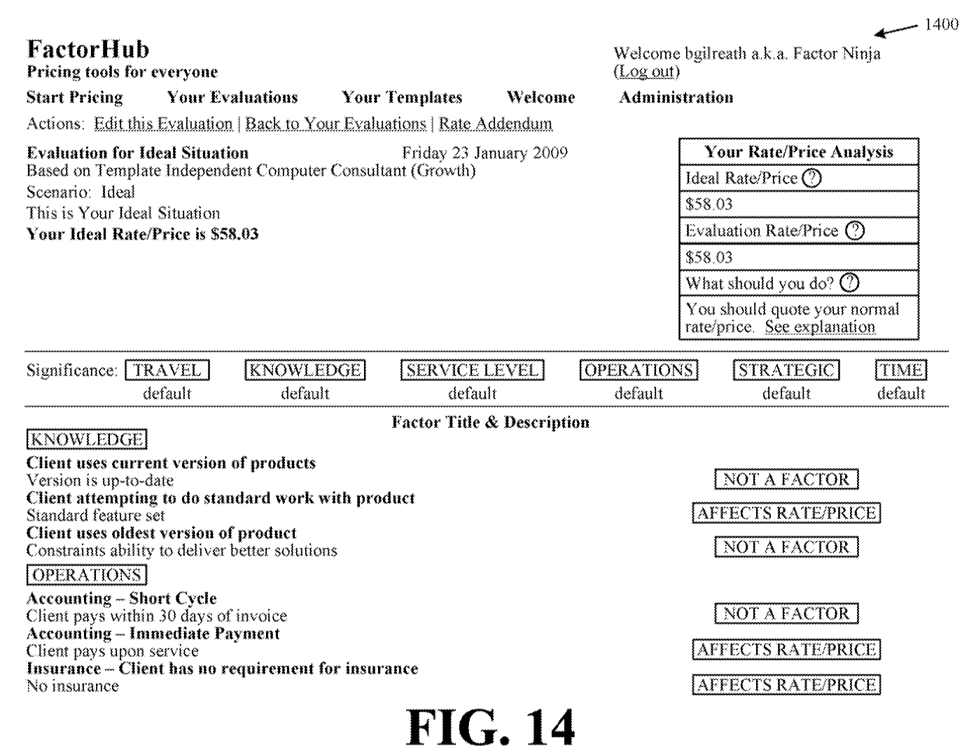

A user, such as a business person 106A or organization manager 106N, can interact with a client device, such as a personal computer like 104A, or mobile device like 104N, via any number of input and output devices, such as an output display device, keyboard, and/or a mouse. In this manner, business person 106A and organization manager 106N can access one or more webpages on a website, such as www.factorhub.com, facilitated by the host server 108 via a browser application program, such as 114, operating on a client device 104A-104N. FIGS. 12-14 illustrate example webpages facilitated by an example website in accordance with certain embodiments of the invention. According to one example embodiment, a business person 106A can input one or more factors or factor information associated with a business person 106A via the respective client device 104A, or the organization manager 106N can input information associated with an organization via the respective client device 104N. The business person 106A may interact with the respective client device 106A to create one or more evaluations and to create one or more templates. The organization manager 106N may interact with the respective client device 104N to assign resources of an organization based on at least one or more templates. After one or more evaluations and templates have been entered into the client device(s) 104A-104N and processed by the host server 108, the client device(s) 104A-104N can facilitate providing an output to the business person 106A and organization manager 106N.

Other system embodiments in accordance with the invention can include fewer or greater numbers of components and may incorporate some or all of the functionality described with respect to the system components shown in FIG. 1.

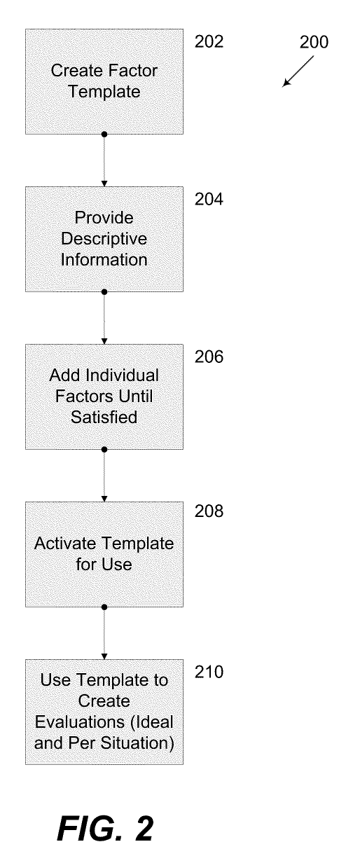

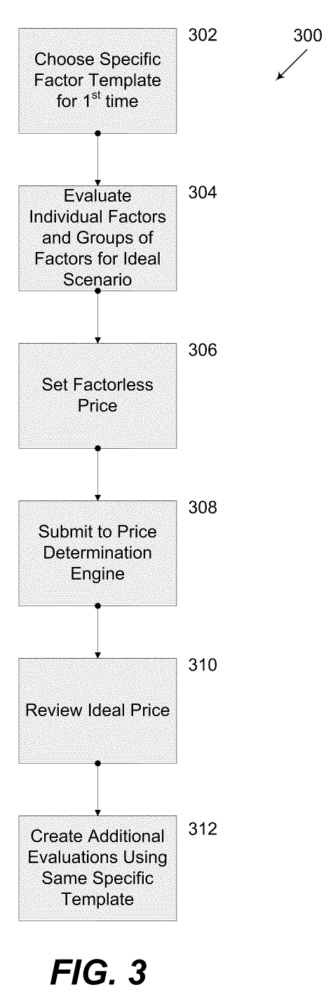

Turning to FIGS. 2 and 3, various methods can be implemented by the system 100 to determine a factor-based price for products and services. For example, using the method 200 in FIG. 2, also called a template creator role process, can be used to create a template. A user such as a business person 106A in FIG. 1 can implement the method 200 or template creator role process. The method 200 or template creator role process can be used to create one or more factors to be used by an evaluation creator role process in assessing one or more business clients. A factor can be, for example, a component of a template, used in an evaluation, to assess a task, capability, avoidance, requirement, or other component of a topic described by the template. The factor can include, but is not limited to, a category, name and/or title, description, impact, help, mitigation, and answer set. A template can include, but is not limited to, a title, description, and a costing basis, for example, a factorless price along with the factor set.

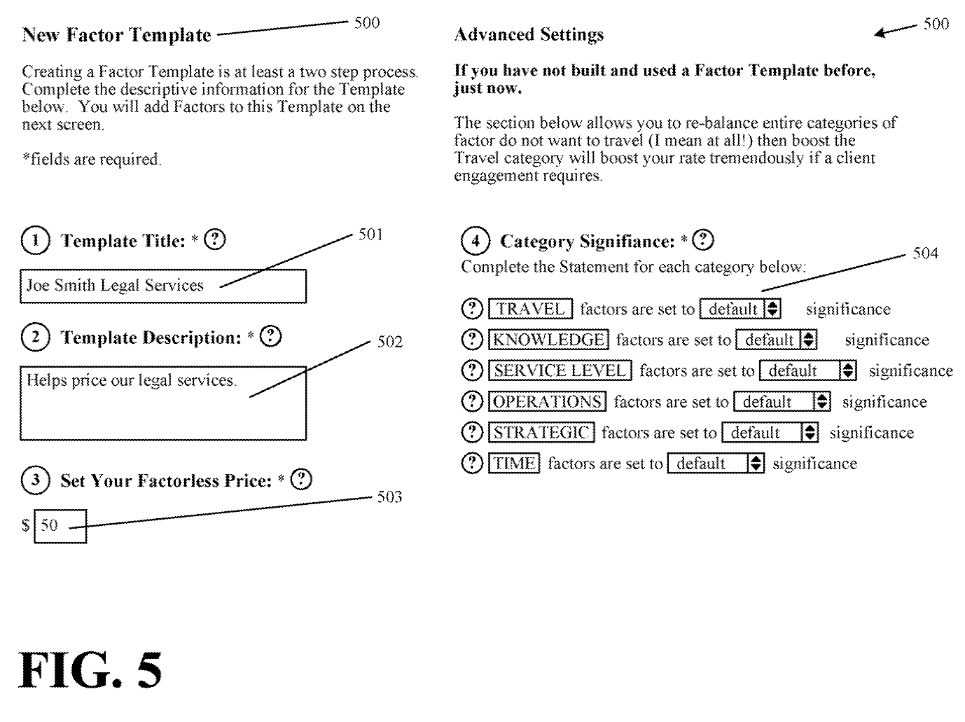

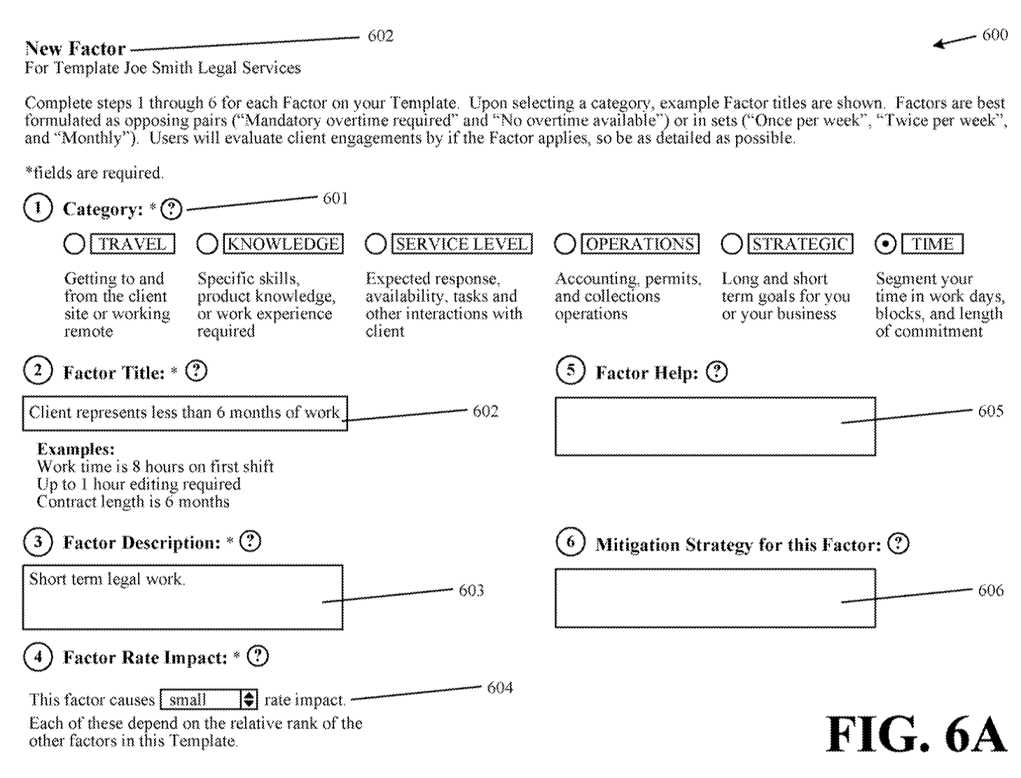

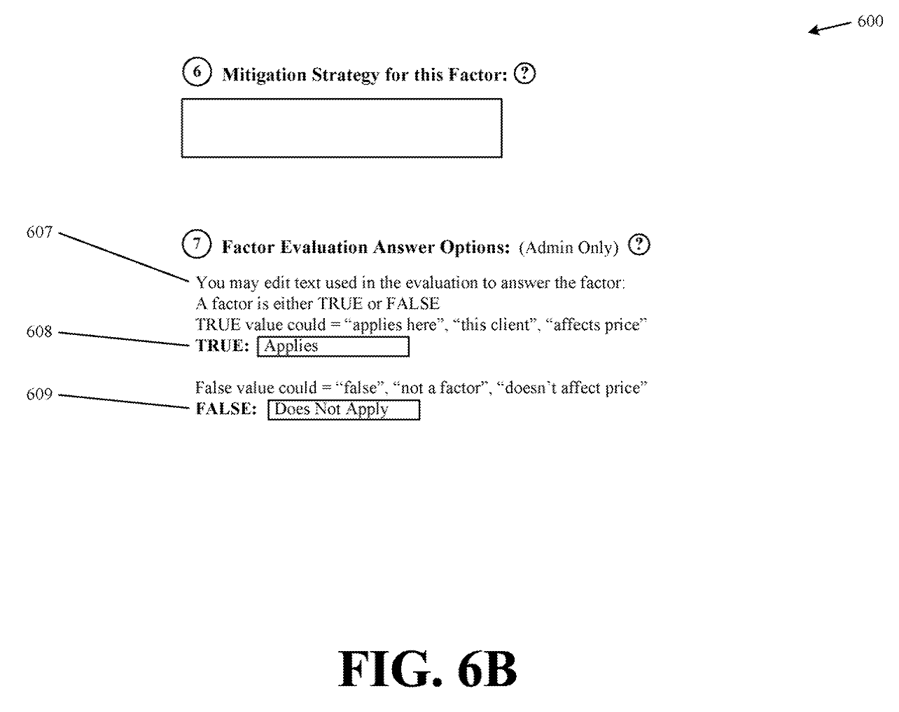

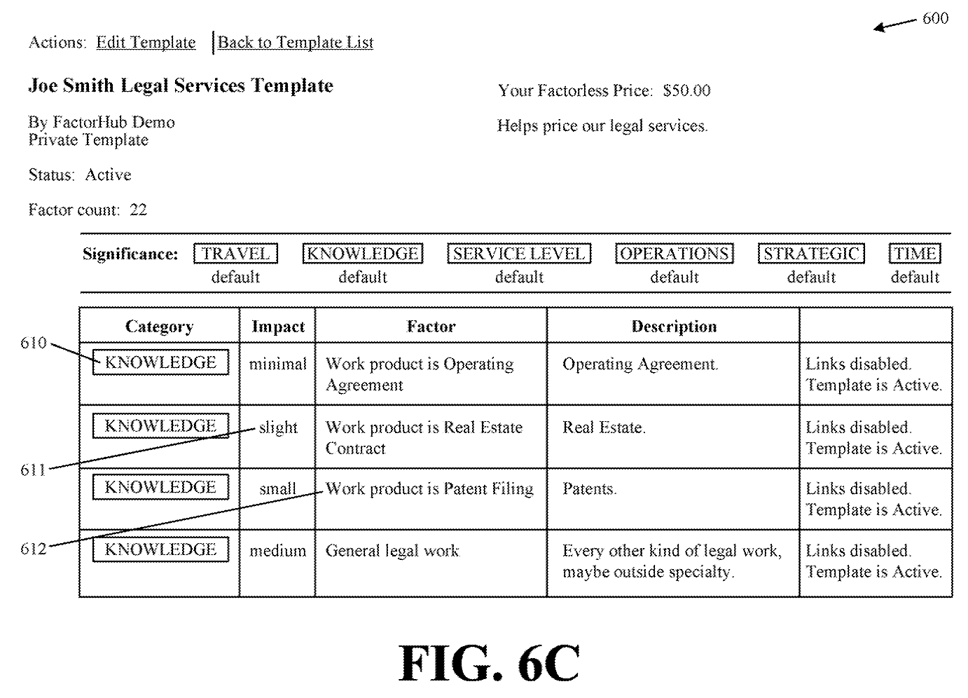

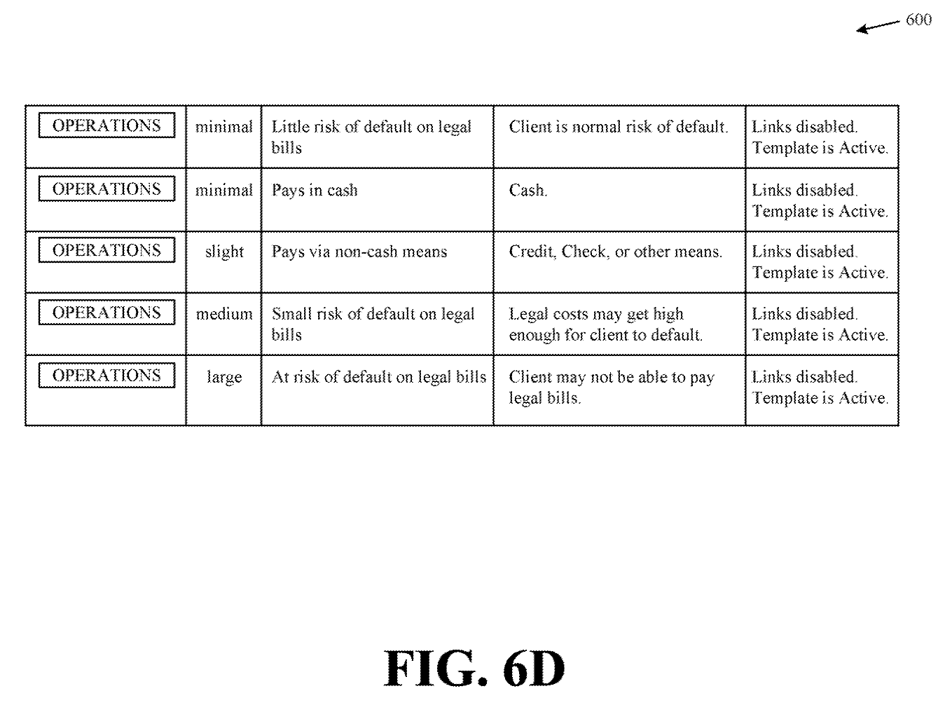

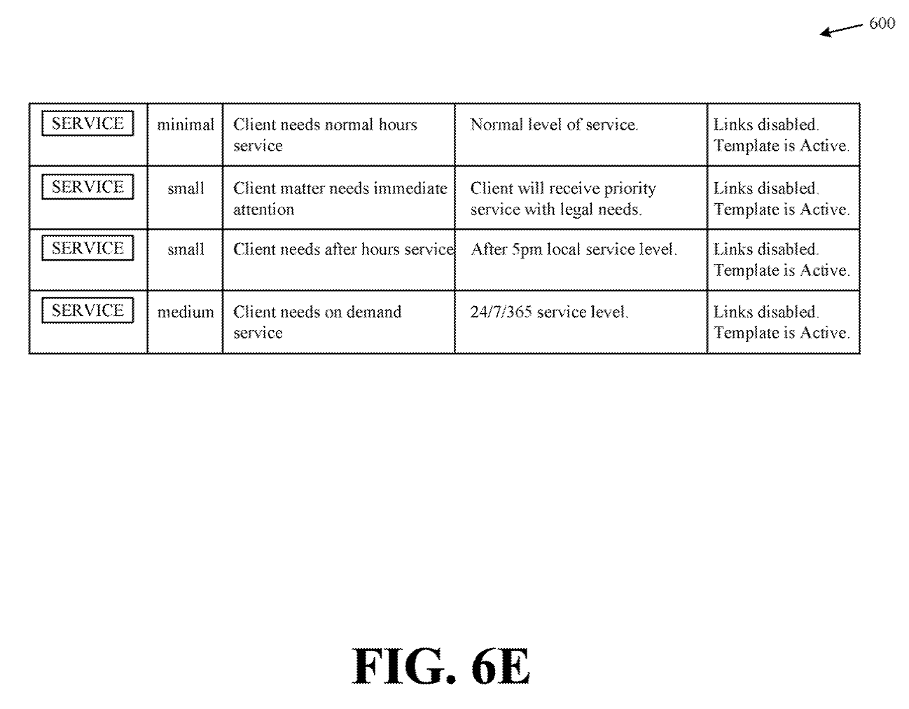

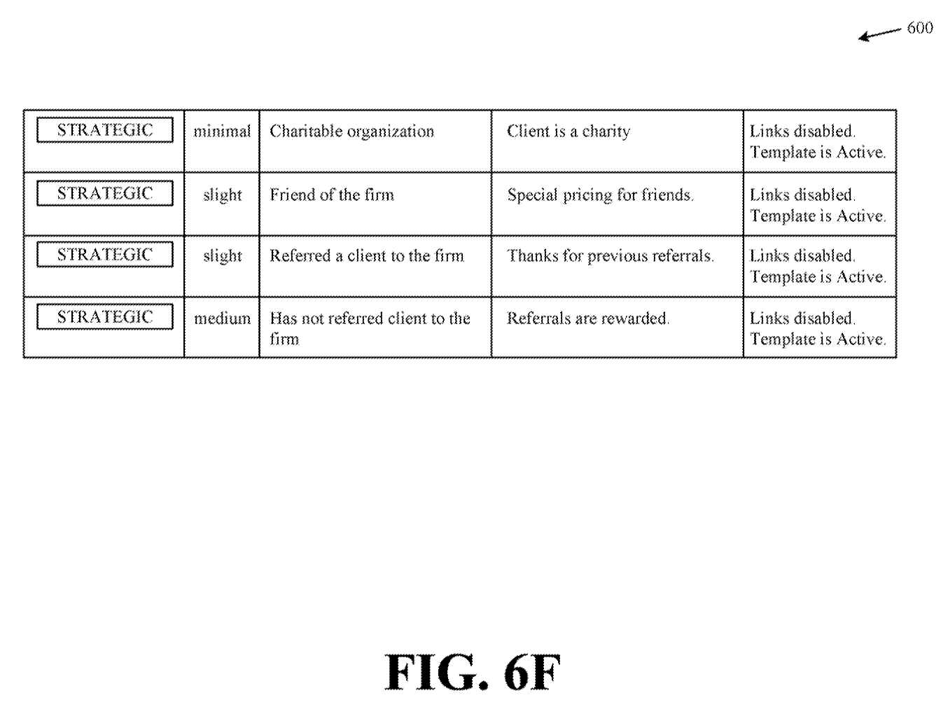

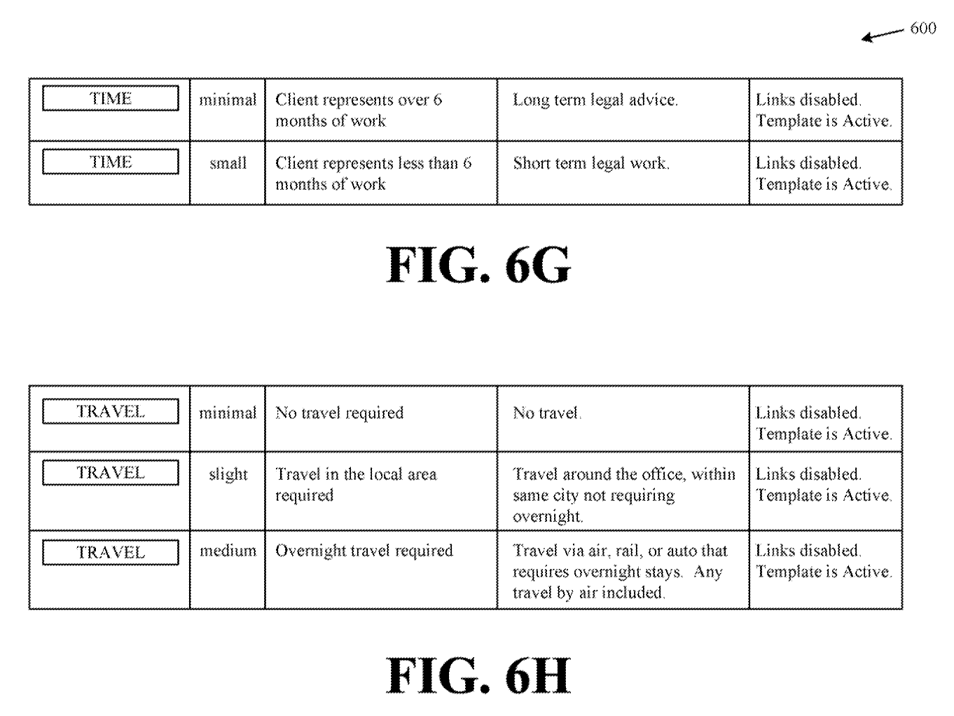

As shown in block 202 of the method 200, a factor template is created. Using a client device such as 104A, a user such as a business person 106A can create or otherwise generate a template, such as a factor template, via one or more webpages or website accessible via a browser application program 114 and the network 102. Some or all of the webpages or website are generally facilitated by the host server 108 and/or the price determination application or engine, such as 126. Example webpages of a website for creating a template are shown and described with respect to FIGS. 5, and 6A-6H.

Block 202 is followed by block 204, in which descriptive information is provided for the template of interest. In this embodiment, the user such as business person 106A can provide a unique title and detailed description associated with the purpose and potential uses of the template. For example, as shown in FIG. 5, the user can uniquely name the template 500 by providing a title 501 such as “Joe Smith Legal Services.” Further, the user can provide a description 502 for the template such as “Helps price our legal services.”

Furthermore, in this embodiment, the user can provide a factorless price. The factorless price can be used as a costing basis for some or all of the entire template. In certain instances, this can be changed only in the ideal evaluation as other users costs might not be equal. In certain instances, the factorless price can be critical in ideal and evaluation rate/price movement. The factorless price generally represents a combination of the real or accounting minimum costs incurred for rate determination, the lowest value the user would work for if the user had no price discrimination, and an arbitrary number used to get an ideal rate/price point. As shown in FIG. 5, the user can provide a factorless price 503, for example, $50.

In addition, the user can enter via the newly created template, various factors to be used in the template of interest. As shown in FIG. 6A, a user such as business person 106A can enter one or more factors 600. Factors can be classified into one or more categories 601 for ease of use or analysis. Factors can also be arranged or detailed in any manner that makes sense to the user. Generally, each category can be fixed or flexible. As shown in FIG. 6A, the user can enter data to uniquely identify one or more factors and associated categories, such as factor titles 602, factor descriptions 603, and factor rate impact 604.

The factor categories shown in the example embodiment are not intended to be a rigid set of factor categories, and in certain embodiments, users can define, set, and use their own categories of factors. Furthermore, the number of the categories in the example embodiment are used to classify the currently used factors, and are not intended to be limiting of any embodiment since any number of categories can be used depending on the factors used in each template.

In this embodiment, factor help can be input by a user to assist in assessing a particular engagement. As shown in FIG. 6A, factor help 605 can be input via the webpage. In addition, a mitigation strategy can be input by a user as one possible solution for a factor offered to another user, also referred to as a business client. As shown in FIG. 6A, a mitigation strategy 606 can be input via the webpage. Moreover, an answer set can be input by a user as a set of labels the user has an option to choose when evaluating the factor. As shown in FIG. 6B, factor evaluation options 607 or an answer set can be input via the webpage. Further, the user can input particular text used in an evaluation to answer a factor, such as “TRUE” 608 or “FALSE” 609.

In this embodiment, the user can also provide one or more options to rate the impact on price or rate of a particular factor or category. In certain instances, impact can be described as an abstract, relative rating, but in other instances, impact could be derived as a certain cost (i.e., —$5.00 or $345.67). As shown in FIG. 6C, the user can input for each category 610, a possible impact 611 on each particular factor 612. FIGS. 6D-6H illustrate other example categories, impacts, and factors.

In other embodiments, the system 100 and/or method 200 can allow the user to calculate the impact using a relatively simple game theory matrix or regular number input. The closer this number is to a real cost, the most accurate real price could be returned by the algorithm.

Turning back to method 200 in FIG. 2, block 204 is followed by block 206, in which individual factors are added until the user is satisfied. For instance, the process illustrated for block 204 can be repeated for any number of factors to be used in the template of interest.

Block 206 is followed by block 208, in which the template can be activated for use. In this embodiment, the user can indicate in the template whether the template is ready to be used by evaluations and shared with other users to apply in evaluations.

Block 208 is followed by block 210, in which if the template is indicated as ready for user, the template can be used to create evaluations. In this embodiment, the template, when ready for use, can be used in any number of ideal situations or particularly identified situations.

After block 210, the method 200 ends.

To further illustrate the method 200 of FIG. 2, by way of example, a user such as 106A can be a lawyer, Joe Smith. Joe Smith is solo practitioner with his own law firm. Joe offers a specific set of legal services: patent prosecution, contract preparation, and preparing operating agreements, but he is capable of performing other legal work. While Joe is a talented lawyer, he cannot work 24 hours in a day for any sustainable amount of time. He needs to compensate by structuring his pricing or billing rate based on a set of factors to optimize the hours he can sustainably work. Using a client device, such as 104A, Joe logs into a website with a series of webpages, similar to those described above in FIGS. 5, and 6A-6H. The website can be facilitated by a host server, such as 108, with a price determination application or engine, such as 126. Joe wants to get a pricing method for his legal services, so he creates a new factor template for his law practice to determine a suitable price or billing rate for his services. Joe creates a factor template such as 500 in FIG. 5, via the website, and names it “Joe Smith Legal Services” 501. The template contains all the factors Joe wants to include when making pricing decisions, including the type of services Joe offers. Joe inputs data via the website including a template title 501, template description 502, and factorless price 503. Optionally, but premature in this case, he could set the significance of the categories of factors for this template 504.

Joe currently charges $200 per hour for his legal services. This is not his factorless price 503. Instead, the factorless price 503 is a price he determined arbitrarily, perhaps by checking what his competition charges, and which is probably based on various factors that may not be applicable to his circumstances. When Joe sets his factorless price 503, this is the price at which Joe believes his services would cost if nothing else mattered. While Joe may be willing to do billable work at $100 an hour for a business client, such as for a charity or for a personal friend, this lower rate may be closer to his factorless price 503, but, in this case, still relies on various factors, e.g., the work is for a charitable organization or the work is for a friend of firm. Thus, since these particular factors affect his rate, Joe's factorless price 503 is lower than $100 an hour. Deducting an arbitrary figure of, for example, $50 from the $100 per hour rate, Joe's factorless price in this instance is $50, which is input at 503. In other embodiments, other arbitrary figures can be used to determine a factorless price.

In yet other embodiments, the factorless price can be determined as a minimum accounting cost either in per hour or per unit basis. For example, Joe's office space, professional fees, taxes, and overhead may make up his factorless price, which can be input as 503 in FIG. 5.

After creating the initial template, Joe the lawyer can add one or more factors beginning at 600 in FIG. 6A. After defining one or more factors, Joe's selected factors, such as 612 in FIG. 6C, can be organized in categories for at least two purposes to provide clarity and meaning for the factors when viewed collectively, and to separate the total impact on the factor template 500. In this example, Joe can define and add one or more factors 600, 612, and indicate the significance of the factors in any number of different categories as illustrated in FIGS. 6C-6H. In each of FIGS. 6C-6H, the factors 612 are listed with an associated category 610 and impact 611 for this example. When finished and when he is satisfied with the factors and their significance, Joe can activate the template.

In one embodiment of the invention, a method for evaluating one or more factors provided by a template can be implemented. That is, in a method also called an evaluation creator role process, a user such as a business person 106A can initiate an assessment of one or more factors provided by a specific template, such as the template created in FIG. 5. For example, using the method 300 in FIG. 3, or evaluation creator role process, an evaluation of a particular predefined template and the associated factors can be initiated.

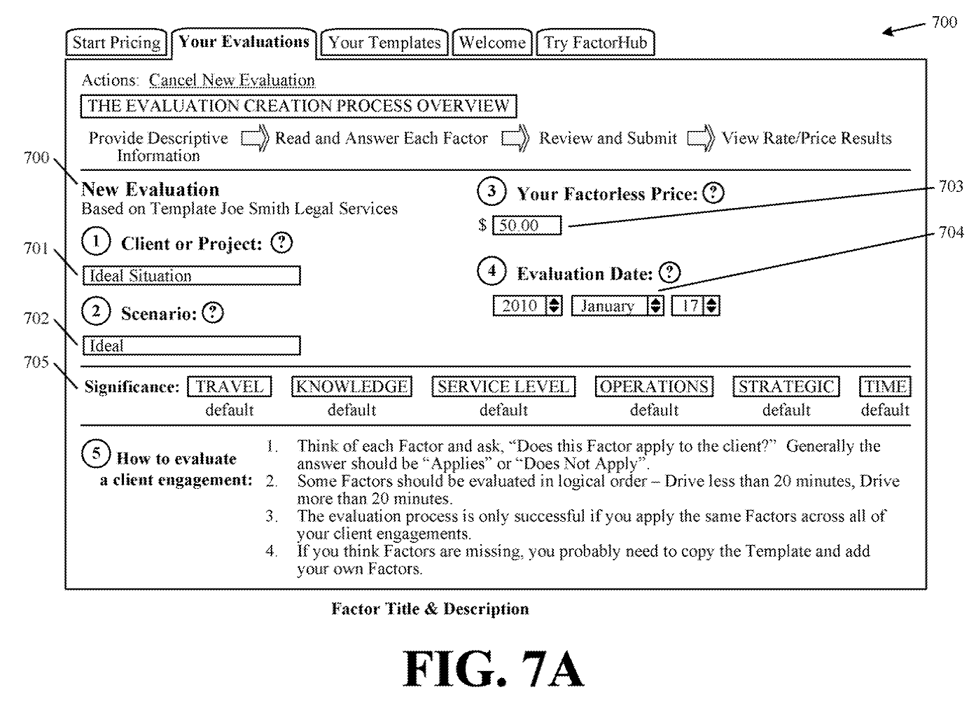

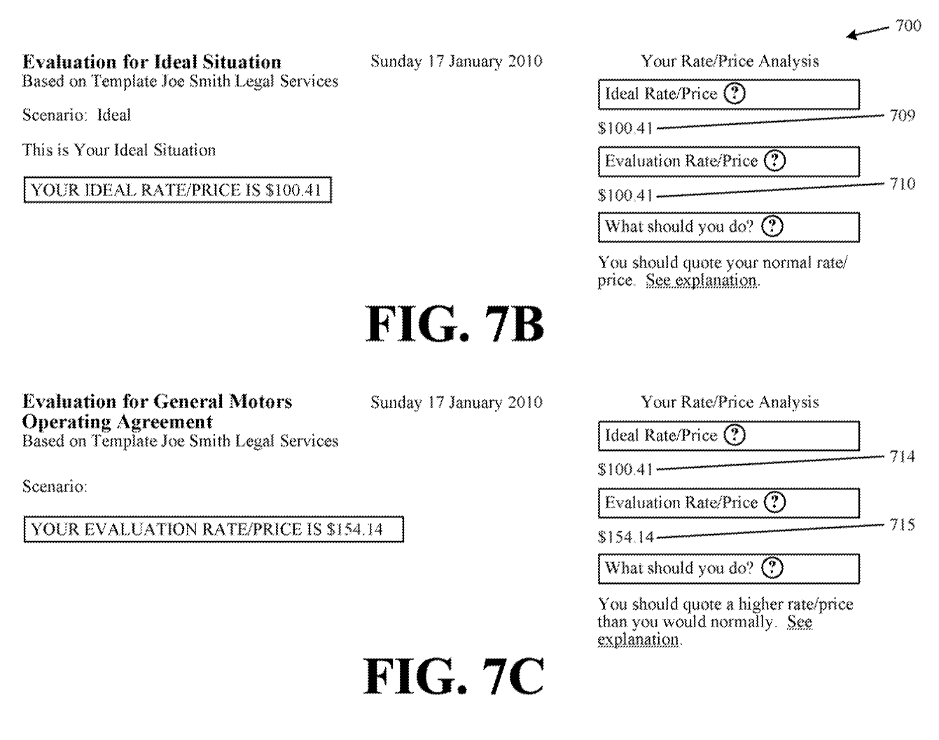

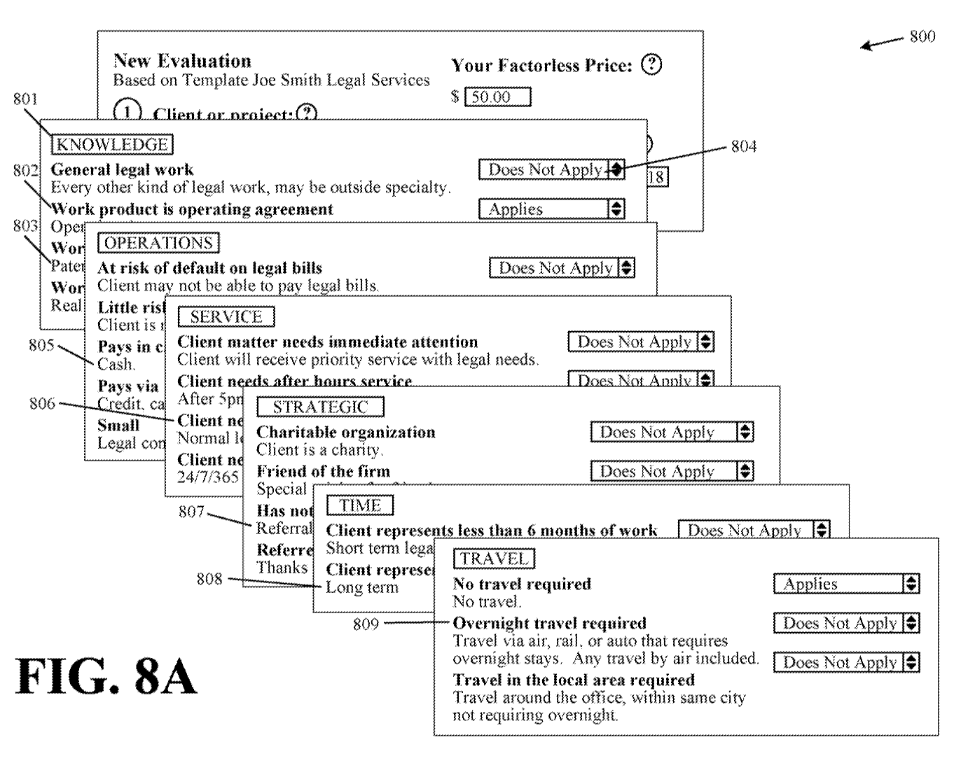

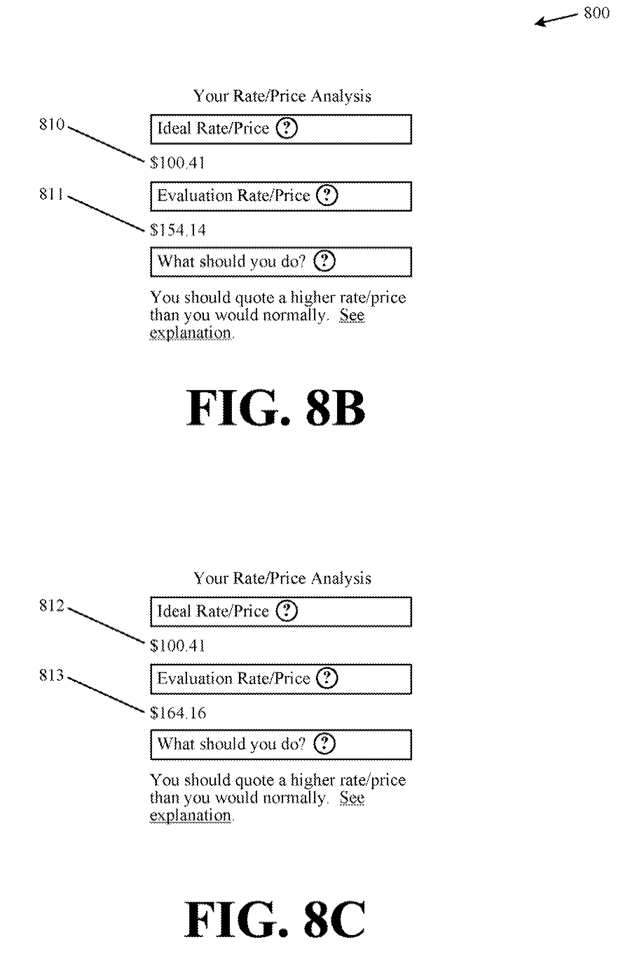

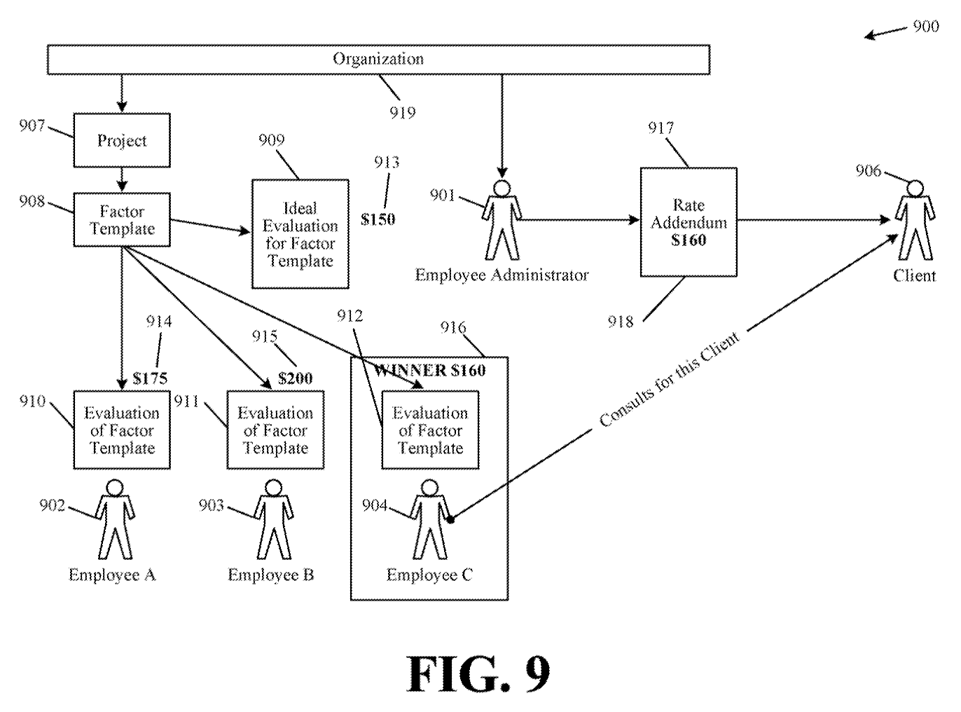

In block 302, the method 300 begins, with selection of a specific factor template for a user's first time. In this embodiment, a business person such as 106A, or any other user or business person, can select a particular template offered on website facilitated by the host server 108 and/or price determination application 126 or engine. The host server 108 and/or the price determination application 126 or engine can populate one or more webpages or a website with data associated with one or more factors previously input in the selected template of interest. Example webpages of a website are shown in FIGS. 7A-7C, and 8A-8C. As shown in FIG. 7A, a webpage with a new evaluation indicated at 700 can be output at a respective client device, such as 104A, for the user or business person 106A. In general, the evaluation 700 can include a list of factors, such as 600 in FIG. 6A, as defined by the template, such as 500 in FIG. 5, to be evaluated by the user.

Block 302 is followed by block 304, in which one or more individual factors and/or groups of factors can be evaluated for an ideal scenario or ideal evaluation. In this embodiment, the user's first evaluation for a specific template can be marked as the ideal evaluation, shown as 701, 702 in FIG. 7A, for that user's subsequent use of the template. Generally, the ideal scenario or ideal evaluation is the set of factors (both positive and negative) that describe a particular user's ideal or otherwise perfect interaction with an imaginary ideal or perfect client.

Block 304 is followed by block 306, in which a factorless price is set. In this embodiment, the host server 108 and/or price determination application 126 or engine can set the factorless price based on prior input from the template of interest. This factorless price is indicated as 703.

Block 306 is followed by block 308, in which the factorless price and other factor associated data is submitted to the price determination application or engine. In this embodiment, the host server 108 and/or price determination application 126 or engine can determine a price or rate based at least in part on one or more factors, such as 600 and the factorless price 703. In one embodiment, certain factors relevant to a particular category can be scored as follows in Table 1:

TABLE 1

| | | | | Line | Category | Category |
|---|---|---|---|---|---|---|
| Category | Factor | Impact | True? | Score | Impact | Score |
| Travel | Travel less than 20 mins | 1 | | | | |
| Travel | Travel between 20 and 40 mins | 2 | true | 4 | | |
| Travel | Travel more than 40 mins | 5 | | | | |
| | Category Totals | | | 4 | 1 | 0.50 |
| Strategic | Client has referred business | 1 | true | 2 | | |
| | recently | | | | | |
| Strategic | Client has not referred | 3 | | | | |
| | business | | | | | |
| Strategic | Engagement will allow | 2 | | | | |
| | learning of new skills | | | | | |
| | Category Totals | | | 2 | 1 | 0.33 |

Other factors and categories may be used as well as other impacts and scores for other embodiments of the invention.

In FIG. 11, an example algorithm for determining a price or rate based at least in part on one or more factors is shown. Factors 1103 with weights 1104 can be arranged into one or more predefined categories 1101. All weights of used factors 1102 can be evaluated against unused factors 1102, which can return a factor raw score 1105. Category weights 1106 can be applied to the factor raw score 1105, which can return a category raw score 1107. All of the category raw scores 1107 can be totaled for a template raw score 1108. A scale or other modifiers 1109 can be applied to the template raw score 408 to calculate or otherwise determine a final score, rate, or price 1110. Other algorithms, methodologies, and/or logic can be utilized by the price determination application 126 or engine in accordance with other embodiments of the invention.

Turning back to FIG. 3, block 308 is followed by block 310, in which an ideal price is output and reviewed. In this embodiment, the host server 108 and/or price determination application 126 or engine can output an ideal price to the client device 104A for review by the user or business person 106A. The determined price or rate can be referred to as the ideal price or ideal rate. The ideal rate or ideal price can be used in comparison for the user's subsequent evaluations using the same template.

Block 310 is followed by block 312, in which one or more additional evaluations are created using the same specific template. In this embodiment, additional evaluations for the user with the same template such as 500 can be assessments of specific clients or projects or scenarios relating to expected/potential work. For example, they could be of past client engagements or current client engagements. Further evaluations can be initiated using the methodology described above in blocks 302-310. Each evaluation can be uniquely identified by name and/or title 700, scenario identifier 704, or an evaluation date 704. In this manner, any number of subsequent evaluations using the same template, can be generated using the set of factors 600 (both positive and negative) that describe a specific interaction with a specific client such as 712, and a rate or price can be derived from this set of factors. The determined price in subsequent scenarios can be referred to as the evaluation price or evaluation rate 713, 715. Generally, a comparison of the ideal price or ideal rate with the evaluation price or evaluation rate can yield an assessment of whether the user should raise, lower, or maintain the price or rate for that client engagement.

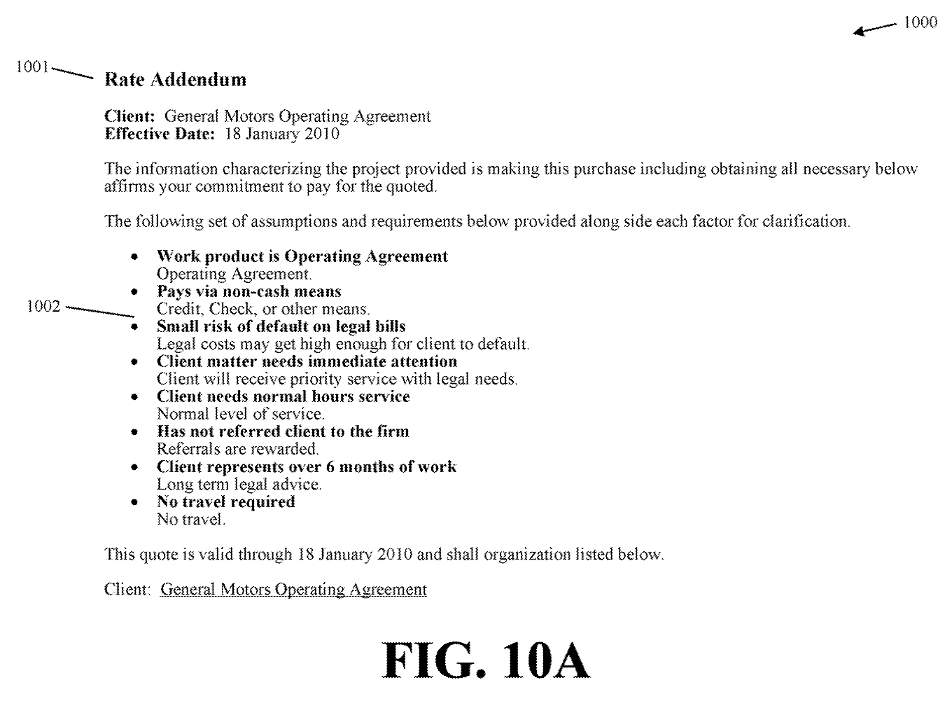

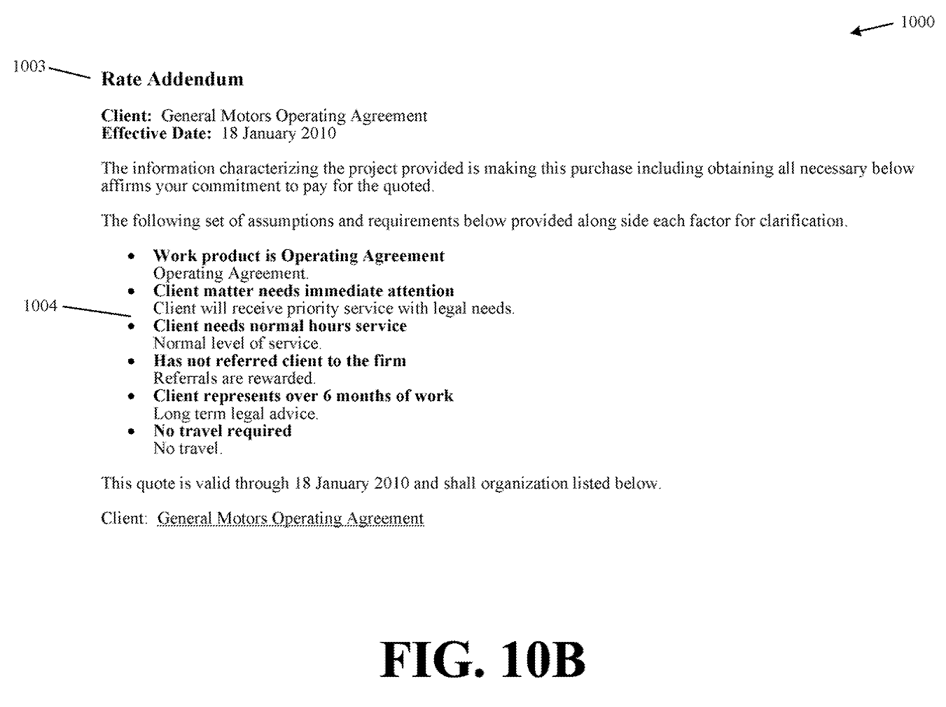

Block 312 is followed by optional block 314, in which a rate addendum can be generated. In certain embodiments, a rate addendum such as 1000 in FIGS. 10A-10B can be prepared by the price determination application 126 or engine. The rate addendum can list some or all of the factor components 1002. Typically, the two parties in the negotiation can use the addendum 1000 as a framework to set the price. The business client can then view some or all of the factors affecting the price, and the parties may decide to alter the rate upon further negotiation based on some or all of the factors. The advantage in a negotiation is the price quoting party is able to layout clear terms as justification of the price. A potential client or customer can eliminate these clear factors with expectation that the initial quoted price will be lowered upon re-evaluation of the terms. In this manner, transparency in price may lead to more equity between the parties in negotiation.

The method 300 ends after block 314.

FIGS. 7B and 7C illustrate comparisons of an ideal scenario with a subsequent scenario for particular desired client engagements. As shown in FIG. 7B, the ideal evaluation 706 includes an ideal scenario 707 based on the set of factors used in the template of interest. Based at least on the set of factors and factorless price, an ideal rate/price 708 can be determined. The analysis by the host server 108 and/or price determination application 126 or engine is output 709, 710 for the user to view and to make a decision. In certain embodiments, guidance in the form of an assessment 711 of whether the user should raise, lower, or maintain the rate/price for the engagement can be provided to the user, such as “You should quote your normal rate/price.”

In FIG. 7C, a particular evaluation 712 is shown for a template of interest 717 with an evaluation rate/price 713. Based at least on the set of factors and factorless price, an ideal rate/price 714 can be determined. The evaluation analysis by the host server 108 and/or price determination application 126 or engine is output 715 for the user to view and to make a decision. In certain embodiments, guidance in the form of an assessment 717 of whether the user should raise, lower, or maintain the rate/price for the engagement can be provided to the user, such as “You should quote a higher rate/price than you would normally.”

In this embodiment, the evaluation rate/price as well as the ideal rate/price can be generated and output in units that are relative to the user's currency or perspective. For example, these could be output in real numbers, in U.S. dollars or Euros, any currency amount, or arbitrary units. In certain embodiments, relationships to real currency could be made with a ratio solve method from the current rate.

To further illustrate the method 300 of FIG. 3, using the above example, the lawyer Joe Smith can create a first evaluation 700 using the template 500 shown in FIG. 5. The initial evaluation can be referred to as the ideal evaluation 701 since it is the ideal scenario 702 for Joe. After marking his preferences via the evaluation 700, the rate determined by the price determination application 126 is $100.41. This is extremely close to the current rate ($100.00) Joe was charging above, and may be justification that the factorless price 503, 703 and factor template 500 are accurately modeled.

Referring to FIGS. 8A-8C for this example, General Motors (GM) later calls Joe Smith and asks him to prepare an operating agreement for a new joint venture. Joe creates, for example, at least two more evaluations 800 to model a price based on his new factor template 500. On each evaluation, Joe reads through each factor category 801, 805, 806, 807, 808, 809 from the factor template 500. Within each category 801, Joe reads the factor name 802 and factor description 803, and he makes an assessment of the situation being currently evaluated and determines whether each factor applies 804. The first and second evaluations for GM are similar, but the only difference, outside of the calculated price, is the application of a travel factor. In the non-traveling scenario of FIG. 8B, the price determination application or engine 126 returns a price 811 of $154.14, whereas in the traveling scenario of FIG. 8C the price 813 is returned as $164.16. Since both of these prices 811, 813 are greater than the ideal rate/price 812 of $100.14, guidance is provided in both subsequent evaluations that “You should quote a higher rate/price than you would normally.”

Furthermore, Joe, in his dealings with GM, can use the price determination application 126 or engine to output or print rate addendums, such as 901, 903 in FIG. 9, based on the correct evaluation 800. As an extra feature, Joe may want to hide 904 some of the factors 904 used, for instance, the default risk and payment types expected.

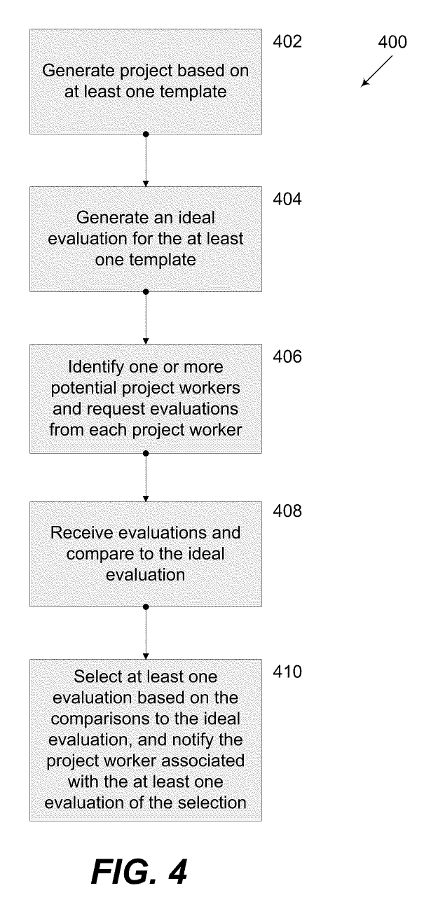

Turning to FIG. 4, a method for assigning resources can be implemented. In a method 400 also called an organizational manager role process, a user such as an organizational manager 106N can identify one or more team members and templates, create projects, and evaluate the resources for allocation by way of initiating ideal evaluations and client evaluations. For example, using the method 400 in FIG. 4, or organizational manager role process, an organizational manager can determine the price of a client engagement based upon who is assigned to that engagement. In this manner, an organization manager can efficiently assign resources based on evaluations individual members have completed.

The method 400 begins at block 402, in which a project based on at least one template is generated. In this embodiment, a user such as an organizational manager 106N can input project data via a client device 104N to a webpage or website facilitated by a host server 108 or price determination application 126 or engine.

Block 402 is followed by block 404, in which an ideal evaluation for the at least one template is generated or otherwise obtained. In this embodiment, the user such as the organizational manager 106N can input evaluation data via a client device 104N to a webpage or website facilitated by a host server 108 or price determination application 126 or engine.

Block 404 is followed by block 406, in which one or more potential project workers are identified and evaluations are requested from each project worker. In this embodiment, the user such as the organizational manager 106N can transmit one or more requests to employees via a client device 104N and network 102 to submit an evaluation. The host server 108 or price determination application 126 or engine can monitor the requests and update the user or organizational manager 106N as needed.

Block 406 is followed by block 408, in which the evaluations are received and compared to the ideal evaluation. In this embodiment, the user such as the organizational manager 106N can review and compare evaluation data via a client device 104N, which the price determination application 126 or engine has provided via a webpage or website.

Block 408 is followed by block 410, in which at least one evaluation is selected based on the comparisons to the ideal evaluation, and the project worker associated with the at least one evaluation is notified of the selection. In this embodiment, the user such as the organizational manager 106N can select at least one employee based in part on the evaluation data via a client device 104N, and the organizational manager 106N can notify the employee via the client device 104A and network 102.

The method 400 ends after block 410.

By way of example, and referring to FIG. 9, in a professional services organization each employee can have a specific skill set, individual goals and ambitions, and particular complaints for a particular work activity. For instance, ABC Systems is an information technology consultancy primarily concerned with installing, operating, upgrading, and maintaining technical systems. ABC Systems hopes to utilize their consulting staff in a most profitable way without sacrificing the consultants' own goals and perceived happiness. Using the system 100 and methods implemented therein, ABC Systems can mitigate the needs of the organization, the client pool, and the consultant pool.

Initially, a business manager 901 for ABC Systems can log into a website, such as www.factorhub.com. The business manager or other organization manager can set up a template, similar to 500 in FIG. 5, that all engagements from all clients will be evaluated. An ideal evaluation, similar to 700 in FIG. 7A, can be created to match one or more strategic goals of the organization. A project can then be assigned to a specific template, and a client evaluation can be created. Each member of the organization then completes an evaluation based on the template used. This is the member's ideal situation.

ABC Systems is assumed to already have created a factor template such as 908, and as described in the example involving Joe Smith. A business manager 901 or other organizational manager for ABC Systems can set up a project 907 using the system 100 that contains, for example, a client name, a project name/number, start and end dates, a description, and a factor template 908 utilized in evaluating the project 907. The business manager 901 or other organizational manager for ABC Systems can also complete an ideal evaluation 909 for the factor template 908 specified by the project 907. In certain instances, an ideal evaluation 909 may already exist for the factor template 908, as the organization's 919 service offerings are probably reused across the client pool.

In this example, three employees 902, 903, 904 can be identified for the project 907, and each employee completes respective evaluations 910, 911, 912 for this factor template 908 and project 907.

The business manager 901 or other organizational manager for ABC Systems can review the list of employees' ideal evaluations and their rates, and can compare the organization's ideal price 913 with each employee's evaluation prices 914, 915, 916. Each evaluation price 914, 915, 916 represents each employee's ideal situation for the project 907. An example comparison is shown below in Table 2:

TABLE 2

| Organization's | | |
|---|---|---|
| Ideal | Client Engagement | Employees' |
| Rate/Price | Evaluation Rate/Price | Ideal Rate/Price |
| $175 | $190 | $160 |
| | | $170 |
| | | $175 |
| | | $178 |
| | | $180 |
| | | $190 |
| | | $200 |

The business manager 901 or other organizational manager for ABC Systems can choose the arbitrage of the employees 902, 903, 904 with the lowest price (golf scoring) 914, 915, 916 relative to the client 913. If the organization can place employees with lower ideal rates 914, 915, 916 than the client evaluation rate 913, then the client evaluation rate would prevail. If the employees are above the client rate 913, an average can be taken and quoted as additional pain serving that client has been determined by the higher average of the employees' evaluation 914, 915, 916.

Certain embodiments of the invention are described above with reference to block diagrams and flowchart illustrations of systems, methods, apparatuses and computer program products. It will be understood that some or all of the blocks of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational elements or steps to be performed on the computer or other programmable apparatus to produce a computer-implemented process such that the instructions that execute on the computer or other programmable apparatus provide elements or steps for implementing the functions specified in the flowchart block or blocks.

Accordingly, blocks of the block diagrams and flowchart illustrations may support combinations of means for performing the specified functions, combinations of elements or steps for performing the specified functions, and program instruction means for performing the specified functions. It will also be understood that some or all of the blocks of the block diagrams and flowchart illustrations, and combinations of blocks in the block diagrams and flowchart illustrations, can be implemented by special purpose hardware-based computer systems that perform the specified functions, elements or steps, or combinations of special purpose hardware and computer instructions.

Additionally, it is to be recognized that, while the invention has been described above in terms of one or more preferred embodiments, it is not limited thereto. Various features and aspects of the above described invention may be used individually or jointly. Although the invention has been described in the context of its implementation in a particular environment and for particular purposes, its usefulness is not limited thereto and the invention can be beneficially utilized in any number of environments and implementations. Furthermore, while the methods have been described as occurring in a specific sequence, it is appreciated that the order of performing the methods is not limited to that illustrated and described herein, and that not every step described and illustrated need be performed. Accordingly, the claims set forth below should be construed in view of the full breadth and spirit of the invention as disclosed herein.

The claimed invention is:

1. A system for factor-based pricing of goods and services, the system comprising:
a price determination engine operable to:
receive a plurality of factors associated with a pricing decision;
apply at least one rule to the plurality of factors to determine a proposed price; and
output the proposed price to at least one client device.

2. The system of claim 1, wherein the system further comprises:
an evaluation creator module operable to:
assess at least one of the plurality of factors to determine an ideal set of factors; and
based at least in part on the ideal set of factors, determine an ideal price.

3. The system of claim 2, wherein the evaluation creator module is further operable to:
based at least in part on factors associated with a particular interaction, determine an evaluation price.

4. The system of claim 3, wherein the evaluation creator module is further operable to:
based at least in part on a comparison of the evaluation price with the ideal price, determine at least one price adjustment for a future interaction.

5. The system of claim 1, wherein the price is expressed in at least one of the following: a rate, a number, a currency, unit of time, or unit of work.

6. The system of claim 1, wherein the system further comprises a template creator module operable to:
based at least in part on a factorless price, provide at least one template to obtain the plurality of factors from at least one user; and
output the at least one template to the user to enter the plurality of factors associated with a pricing decision.

7. The system of claim 1, wherein the plurality of factors comprise at least one of the following: a fixed category, a flexible category, a name, a title, a description, an impact, help, mitigation, or an answer set.

8. The system of claim 1, wherein the system further comprises an organization manager module operable to:
based at least in part on the plurality of factors, assign one or more resources to an engagement.

9. The system of claim 8, wherein the resources comprise at least one of the following:
personnel, equipment, a quantity of goods, or a quantity of services.

10. The system of claim 1, wherein the price determination engine is further operable to:
based at least in part on the plurality of factors, output a rate addendum with at least one factor which can affect the proposed price.

11. A method for factor-based pricing of goods and services, the method comprising:
receiving a plurality of factors associated with a pricing decision;
applying at least one rule to the plurality of factors to determine a proposed price; and
outputting the proposed price to at least one client device.

12. The method of claim 11, further comprising:
assessing at least one of the plurality of factors to determine an ideal set of factors; and
based at least in part on the ideal set of factors, determining an ideal price.

13. The method of claim 12, further comprising:
based at least in part on factors associated with a particular interaction, determining an evaluation price.

14. The method of claim 13, further comprising:
based at least in part on a comparison of the evaluation price with the ideal price, determining at least one price adjustment for a future interaction.

15. The method of claim 11, wherein the price is expressed in at least one of the following: a rate, a number, a currency, unit of time, or unit of work.

16. The method of claim 11, further comprising:
based at least in part on a factorless price, providing at least one template to obtain the plurality of factors from at least one user; and
outputting the at least one template to the user to enter the plurality of factors associated with a pricing decision.

17. The method of claim 11, wherein the plurality of factors comprise at least one of the following: a fixed category, a flexible category, a name, a title, a description, an impact, help, mitigation, or an answer set.

18. The method of claim 11, further comprising:
based at least in part on the plurality of factors, assigning one or more resources to an engagement.

19. The method of claim 18, wherein the resources comprise at least one of the following:
personnel, equipment, a quantity of goods, or a quantity of services.

20. The method of claim 11, further comprising:
based at least in part on the plurality of factors, outputting a rate addendum with at least one factor which can affect the proposed price.

21. A computer-implemented method comprising at least one processor operable to execute a set of computer-executable instructions, the method comprising:
receiving a plurality of factors associated with a pricing decision;
applying at least one rule to the plurality of factors to determine a proposed price; and
outputting the proposed price to at least one client device.
